(19) United States
(12) Patent Application Publication
(10) Pub. No.: US 2021/0019408 A1
(43) Pub. Date: Jan. 21, 2021

(54) MALWARE FAMILY TRACKING AND VISUALIZATION ACROSS TIME

(71) Applicant: Avast Software s.r.o., Praha (CZ)

(72) Inventor: Nikolaos Chrysaidos, Praha (CZ)

(21) Appl. No.: 16/513,639

(22) Filed: Jul. 16, 2019

(51) Int. Cl. G06F 21/56; G06F 21/55

(52) U.S. Cl. CPC G06F 21/566; G06F 21/552; G06F 21/568; G06F 21/564

(57) ABSTRACT

A malware analysis system is operable to select a family of related malware for evaluation from a database of observed malware. The system extracts static and dynamic features of the malware samples from the selected malware family in the database, and an observation time of each of the malware samples from the selected malware family. The system then creates a visualization illustrating change in at least one of static and dynamic features of the selected malware family over time. The system extracts a geographic location of a command and control server associated with malware samples if present, and the created visualization further illustrates the geographic areas in which the malware was found. The system illustrates a group of malware detections as an object having characteristics indicating one or more of the features in the clustered malware detections, and/or the number of features that vary between the clustered malware detections.

### FIELD

The invention relates generally to tracking malicious activity in computer systems, and more specifically to malware family tracking and visualization across time.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users to attempt to communicate with other users' computers in a manner that poses a danger. For example, a hacker may attempt to log in to a corporate computer to steal, delete, or change information. Computer viruses or Trojan horse programs may be distributed to other computers or unknowingly downloaded such as through email, download links, or smartphone apps. Further, computer users within an organization such as a corporation may on occasion attempt to perform unauthorized network communications, such as running file sharing programs or transmitting corporate secrets from within the corporation's network to the Internet.

For these and other reasons, many computer systems employ a variety of safeguards designed to protect computer systems against certain threats. Firewalls are designed to restrict the types of communication that can occur over a network, antivirus programs are designed to prevent malicious code from being loaded or executed on a computer system, and malware detection programs are designed to detect remailers, keystroke loggers, and other software that is designed to perform undesired operations such as stealing information from a computer or using the computer for unintended purposes. Similarly, web site scanning tools are used to verify the security and integrity of a website, and to identify and fix potential vulnerabilities.

All of these methods for detecting malware rely on being able to recognize and characterize malicious code, which is constantly evolving. Many common malware programs are intentionally modified over time to avoid being detected by existing tools, and new malware threats are constantly replacing old ones. With new threats constantly emerging, efficient and timely detection of vulnerabilities within a computer network remain a significant challenge. Further, understanding the evolution of a family of malware can be difficult given the number of features and variations present in many modern sophisticated malware families. It is therefore desirable to efficiently track and understand the evolution of malware threats in computerized systems to help understand the treats being faced and provide efficient detection of vulnerabilities.

### SUMMARY

One example embodiment of the invention comprises a malware analysis system operable to select a family of related malware for evaluation from a database of observed malware. The system extracts static and dynamic features of the malware samples from the selected malware family in the database, and an observation time of each of the malware samples from the selected malware family. The system then creates a visualization illustrating change in at least one of static and dynamic features of the selected malware family over time.

In another example, the system extracts a geographic location of a command and control server associated with malware samples, wherein the created visualization further illustrates the distinct geographic areas in which the malware was found. In a further example, creating the visualization further comprises creating a first visualization for malware samples having geographic location data for a command and control server and a second visualization for malware samples not having geographic data for a command and control server.

In another example, creating a visualization further comprises combining data by observation time period for visualization, the time period for combining data comprises a day, a week, a month, or three months.

In a further example, creating the visualization further comprises illustrating a cluster of malware detections as an object having characteristics indicating one or more of the number of features in the clustered malware detections, the number of malware detections during a period of time, the number of different command and control servers associated with the malware detections in the cluster, and the number of features that vary between the clustered malware detections.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a computer network environment including a malware analysis server operable to generate a graphical representation of the evolution of a family of malware over time, consistent with an example embodiment.

FIG. 2 is a flowchart illustrating a method of creating a malware evolution timeline, consistent with an example embodiment.

FIG. 3 is a malware evolution timeline, consistent with an example embodiment.

FIG. 4 is a computerized malware analysis system comprising a malware analysis module, consistent with an example embodiment.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices become more ingrained into our daily lives, the value of the information they store, the data such as passwords and financial accounts they capture, and even their computing power becomes a tempting target for criminals. Hackers regularly attempt to log in to a corporate computer to steal, delete, or change information, or to encrypt the information and hold it for ransom via “ransomware.” Smartphone apps, Microsoft Word documents containing macros, Java applets, and other such common documents are all frequently infected with malware of various types, and users rely on tools such as antivirus software, firewalls, or other malware protection tools to protect their computerized devices from harm.

But, malware is constantly changing and evolving. Hackers change existing malware programs to avoid detection or to perform new functions, and create new malware for the same reasons or to take advantage of newly-discovered vulnerabilities in computer systems. Those working in the computer security field track the various different types of malware in circulation, such as by receiving reports from antivirus or antimalware software, firewalls, and other such security systems, to focus their work on significant or growing threats. But, tracking and organizing the ever-increasing volume of malware, as well as all the variants of known types of malware, is a significant task and difficult to compile and interpret.

Some examples provided herein therefore seek to improve upon tracking the evolution of malware threats by automatically tracking families sharing certain features in a timeline, including in further examples geographic information and static and dynamic features of families of related malware. In a further example, the tracking includes providing a visualization of the malware threats over time, such as by showing changes in characteristics of a particular family of malware with data clustered by a time period such as a week or a month. Characteristics include malware features such as static features that have not changed over time (but that may be added or removed), dynamic features that change over time, and command and control (often referenced as C&C) server identity or geographic region for malware that communicates with a command and control server.

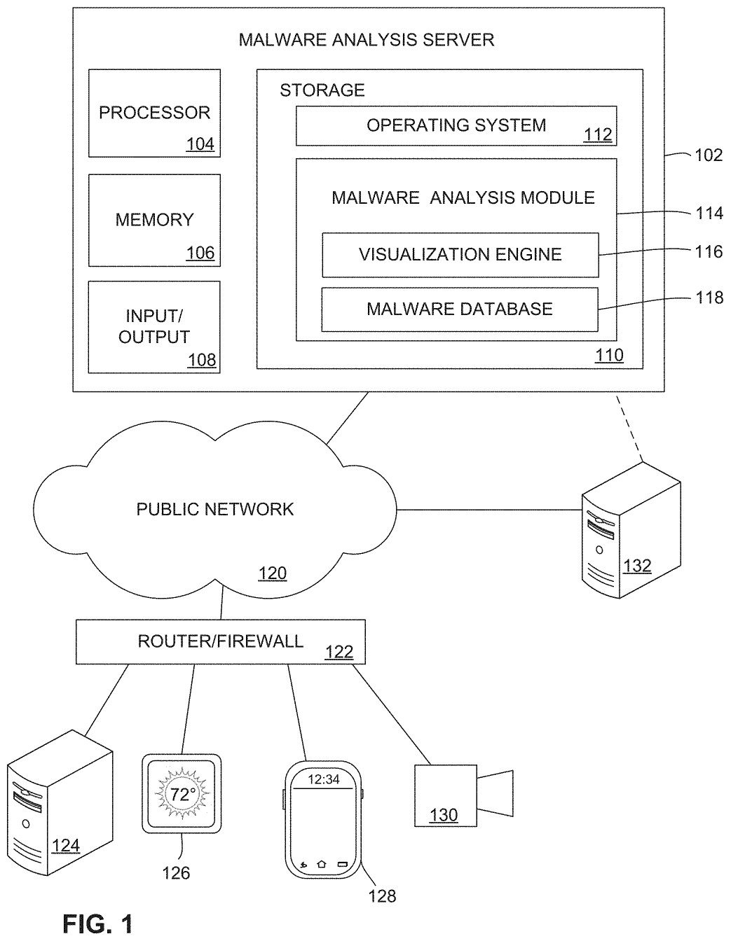

FIG. 1 shows a computer network environment including a malware analysis server operable to generate a graphical representation of the evolution of a family of malware over time, consistent with an example embodiment. Here, a malware analysis server 102 comprises a processor 104, memory 106, input/output elements 108, and storage 110. Storage 110 includes an operating system 112, and malware analysis module 114 that is operable to analyze malware detections stored in malware database 118 and to create a visualization of malware evolution over time using visualization engine 116. The malware analysis server 102 is coupled in this example to a public network 120, which gathers malware reports from devices such as router/firewall 122, computer systems 124, smart Internet of Things (IoT) devices such as smart thermostat 126, smartphone 128, and surveillance or security devices such as video camera 130. When malware is detected in one of these devices, a report of the malware detection is provided to malware analysis server 102, which then stores a record of the malware detection in malware database 118. Computer system 132 enables a user, such as a malware researcher or malware software engineer, to communicate with malware analysis server 102 such as via the public network 120 or via a local/direct network connection.

In operation, malware detection software installed on devices such as personal computer 124 and smartphone 128 monitor incoming network traffic, stored programs, and executing software for malware. When malware is detected, the malware detection software performs one or more actions such as deleting or quarantining the malware, halting execution of the malware, reporting detection of the malware to a device user, and reporting detection of the malware to a networked malware service such as malware analysis server 102. In a further example, devices 124 and 128 are similarly operable to obtain malware signature updates, updated malware detection software, and other such information from a server such as malware analysis server 102 or another server.

Other devices, such as smart thermostat 126 and video camera 130, may not execute their own malware detection software due to their limited computational resources, but are in this example protected by one or more other devices on the network such as router/firewall 122 or a standalone security appliance. The router/firewall 122 or standalone security appliance reports malware detections to malware analysis server 102, which stores a record of the detected malware in malware database 118.

A malware detection software engineer or other malware researcher using computer system 132 wishes to evaluate malware changes over time, such as to determine how malware is spreading or changing over time. The user connects computer 132 to malware analysis server 102, such as by executing malware analysis module 114 on the server as a remote user or by accessing a web interface to malware analysis module 114. The user executes the malware analysis module, causing selected malware records to be retrieved from the malware database 118 and rendered via visualization engine 116 to graphically show changes in various features of a selected malware family or type over time. The rendered visualization or illustration is made available to the user of computer 132 such as by presenting the illustration as a web graphic, as a document for download, or through other suitable means.

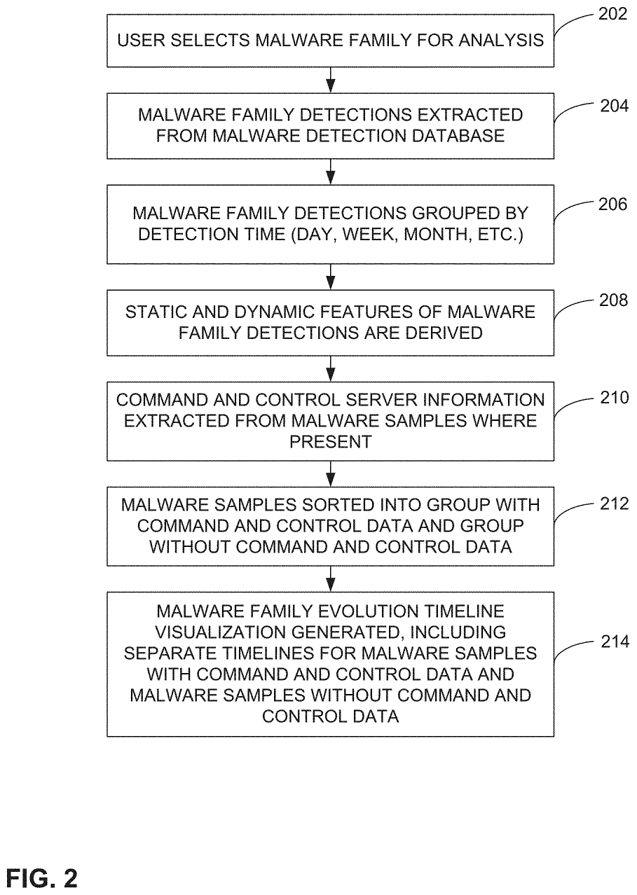

FIG. 2 is a flowchart illustrating a method of creating a malware evolution timeline, consistent with an example embodiment. A user selects a malware family for analysis at 202, such as malware based on the same code base or designed to exploit the same weakness or vulnerability in computerized systems. Malware samples that are a part of the selected family are extracted from a database of observed malware samples at 204, such as from malware database 118 of FIG. 1.

The extracted malware samples are then grouped and processed for visualization. At 206, the malware detections are grouped by detection time, such as by day, week, month, quarter, year, or other suitable period of time. Various features of the malware are extracted at 208, including both static features that do not change across samples from the same family (but can be added or removed) and dynamic features that change across samples within the family. For example, a strain of ransomware may employ the same encryption algorithm across all samples within the same family, but have different text presented to a user and be configured to communicate with different command and control servers.

At 210, command and control server information is extracted from malware samples within the selected family if such information is present in the sample, and the malware samples are sorted into a group of samples having command and control information present and a group of samples not having command and control information present at 212.

Malware family evolution timelines are then generated at 214, including separate timelines for malware samples with command and control data and for malware samples without command and control data where both types of malware samples exist in the family being analyzed for illustration. The timelines show graphically how characteristics or features of the malware in the family vary over time, such as the number of observations of the malware during a time period, the number of changed features in the malware over time, the number of identified static features in the malware, the geographic and/or network location of the command and control servers referenced in the malware, and other such characteristics.

Although the stems in FIG. 2 are listed in a particular order, many steps can occur in a different order than what is shown while achieving the same or similar result. Other examples therefore include only some of the steps of FIG. 2 or additional steps, any of which may be performed in an order other than that shown here.

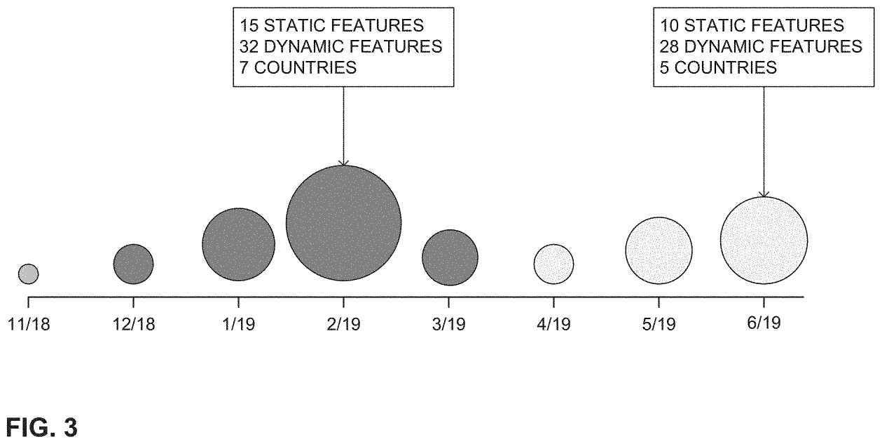

FIG. 3 is a malware evolution timeline, consistent with an example embodiment. In this example, malware observations are clustered by month, showing various characteristics of malware samples in the malware database 118 of FIG. 1 for each month from the months of November 2018 through June 2019. Objects or other graphical features represent various characteristics of each cluster, which in this example are primarily represented by circles with varying characteristics. Here, the size of each circle indicates the number of identified features identified in malware samples in the family being analyzed, such as the number of similar code segments, interactions with external devices such as hard disk drives or network interfaces. The color of each circle indicates the predominant country associated with the Command and Control (C&C) server associated with the malware samples, which in the example shown here are represented by shades of gray due to regulations of the patent process. Further, text boxes associated with some or all boxes give statistical information regarding each group or object, which in a further example are revealed by selecting a particular group such as by bringing the mouse cursor over an object.

The user is then able to visually analyze evolution of the malware family by observing features such as the size, color, associated text, and other characteristics of the objects representing the groupings of malware samples. In the illustration of FIG. 3, a user can see that a new malware family was first observed in November of 2018, and grew from December through February to have an increasing number of observed features but under the command and control of a server in a different country as represented by the darker gray color. In March of 2019, the number of observed features fell, suggesting that at least some variants in the malware family were no longer being observed, such as might be the result of malware or antivirus tools blocking spread of the malware.

In April of 2019, a new light gray color represents that the predominant command and control server referenced by malware samples in the family observed that month is from a different country, suggesting a different person or organization may now be behind the most commonly observed variants of the malware family. In May and June, observations of malware features again continue to climb as different variants of the malware are found and recorded and more features of the modified malware strain are identified. This suggests to a malware researcher such as an anti-malware software engineer that although the first significant outbreak of the malware represented by dark gray may be reasonably well contained, a new strain in the same family is now growing in complexity and may be of interest in developing or improving anti-malware software.

In other examples, other characteristics are employed or different graphical representations are used, such as a bar graph rather than a circle or shapes that vary depending on changing factors observed in the malware samples. In one such example, the size of the circles represents not the number of identified features of the malware samples clustered in the particular time represented, but instead represents the number of samples or frequency of observation in the malware database. In another such example, the circles or other graphical objects are not shown along a timeline, but instead are superimposed on a map, illustrating the prevalence of malware in different geographic or network regions over time. In a further example, time progresses automatically such that the graphic representation is effectively a moving picture, while in other examples the time is user-selectable such as using a slider or keying a date or date range.

The examples presented herein enable a user to view a graphic representation of malware evolution over time, from which the user can focus on changes over time to better understand how a particular family of malware is changing and the threat posed by the malware is evolving. Such information can be useful in understanding threats and risks posed by various strains of malware, as well as in developing antimalware products such as through manual programming or machine learning or in law enforcement. Using graphic objects to represent groups of malware observed at various times along with varying characteristics of the graphic objects to represent features or characteristics of the malware samples in the represented time groups or clusters further facilitates easy and rapid understanding of changes in the features or characteristics of the malware represented in the graphic illustration. Although some examples of computerized systems that may be used to implement various elements of the examples presented herein are shown in examples such as FIG. 1, a variety of other computing devices may be employed to implement some or all elements of various embodiments.

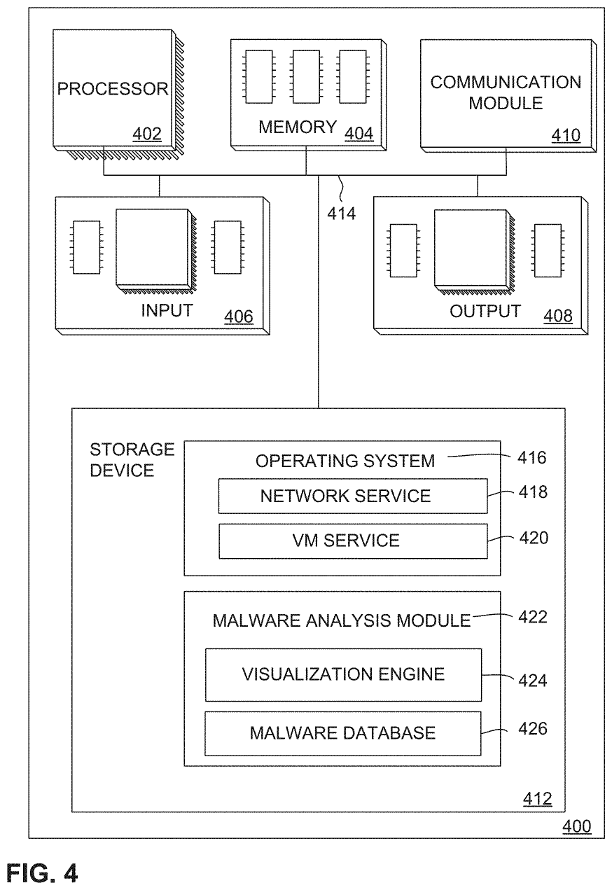

FIG. 4 is a computerized malware analysis system comprising a malware analysis module, consistent with an example embodiment. FIG. 4 illustrates only one particular example of computing device 400, and other computing devices 400 may be used in other embodiments. Although computing device 400 is shown as a standalone computing device, computing device 400 may be any component or system that includes one or more processors or another suitable computing environment for executing software instructions in other examples, and need not include all of the elements shown here.

As shown in the specific example of FIG. 4, computing device 400 includes one or more processors 402, memory 404, one or more input devices 406, one or more output devices 408, one or more communication modules 410, and one or more storage devices 412. Computing device 400, in one example, further includes an operating system 416 executable by computing device 400. The operating system includes in various examples services such as a network service 418 and a virtual machine service 420 such as a virtual server. One or more applications, such as malware analysis module 422 are also stored on storage device 412, and are executable by computing device 400.

Each of components 402, 404, 406, 408, 410, and 412 may be interconnected (physically, communicatively, and/or operatively) for inter-component communications, such as via one or more communications channels 414. In some examples, communication channels 414 include a system bus, network connection, inter-processor communication network, or any other channel for communicating data. Applications such as malware evaluation module 422 and operating system 416 may also communicate information with one another as well as with other components in computing device 400.

Processors 402, in one example, are configured to implement functionality and/or process instructions for execution within computing device 400. For example, processors 402 may be capable of processing instructions stored in storage device 412 or memory 404. Examples of processors 402 include any one or more of a microprocessor, a controller, a digital signal processor (DSP), an application specific integrated circuit (ASIC), a field-programmable gate array (FPGA), or similar discrete or integrated logic circuitry.

One or more storage devices 412 may be configured to store information within computing device 400 during operation. Storage device 412, in some examples, is known as a computer-readable storage medium. In some examples, storage device 412 comprises temporary memory, meaning that a primary purpose of storage device 412 is not long-term storage. Storage device 412 in some examples is a volatile memory, meaning that storage device 412 does not maintain stored contents when computing device 400 is turned off. In other examples, data is loaded from storage device 412 into memory 404 during operation. Examples of volatile memories include random access memories (RAM), dynamic random access memories (DRAM), static random access memories (SRAM), and other forms of volatile memories known in the art. In some examples, storage device 412 is used to store program instructions for execution by processors 402. Storage device 412 and memory 404, in various examples, are used by software or applications running on computing device 400 such as malware analysis module 422 to temporarily store information during program execution.

Storage device 412, in some examples, includes one or more computer-readable storage media that may be configured to store larger amounts of information than volatile memory. Storage device 412 may further be configured for long-term storage of information. In some examples, storage devices 412 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 400, in some examples, also includes one or more communication modules 410. Computing device 400 in one example uses communication module 410 to communicate with external devices via one or more networks, such as one or more wireless networks. Communication module 410 may be a network interface card, such as an Ethernet card, an optical transceiver, a radio frequency transceiver, or any other type of device that can send and/or receive information. Other examples of such network interfaces include Bluetooth, 4G, LTE, 5G, WiFi, Near-Field Communications (NFC), and Universal Serial Bus (USB). In some examples, computing device 400 uses communication module 410 to wirelessly communicate with an external device such as via public network 120 of FIG. 1.

Computing device 400 also includes in one example one or more input devices 406. Input device 406, in some examples, is configured to receive input from a user through tactile, audio, or video input. Examples of input device 406 include a touchscreen display, a mouse, a keyboard, a voice responsive system, video camera, microphone or any other type of device for detecting input from a user.

One or more output devices 408 may also be included in computing device 400. Output device 408, in some examples, is configured to provide output to a user using tactile, audio, or video stimuli. Output device 408, in one example, includes a display, a sound card, a video graphics adapter card, or any other type of device for converting a signal into an appropriate form understandable to humans or machines. Additional examples of output device 408 include a speaker, a light-emitting diode (LED) display, a liquid crystal display (LCD), or any other type of device that can generate output to a user.

Computing device 400 may include operating system 416. Operating system 416, in some examples, controls the operation of components of computing device 400, and provides an interface from various applications such as network traffic anomaly RNN training module 422 to components of computing device 400. For example, operating system 416, in one example, facilitates the communication of various applications such as malware analysis module 422 with processors 402, communication unit 410, storage device 412, input device 406, and output device 408. Applications such as malware analysis module 422 may include program instructions and/or data that are executable by computing device 400. As one example, malware analysis module 422 evaluates data from malware database 426 to create a visual representation of the data using visualization engine 424, such that a graphical representation of the evolution of one or more families of malware over time is generated. These and other program instructions or modules may include instructions that cause computing device 400 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of analyzing detected malware, comprising:
selecting a family of related malware for evaluation from a database of observed malware;
extracting static and dynamic features of the malware samples from the selected malware family in the database and an observation time of each of the malware samples from the selected malware family; and
creating a visualization illustrating change in at least one of static and dynamic features of the selected malware family over time.

2. The method of analyzing detected malware of claim 1, further comprising extracting a geographic location of a command and control server associated with malware samples, wherein the created visualization further illustrates the number of distinct geographic areas in which the malware was found.

3. The method of analyzing detected malware of claim 2, wherein the distinct geographic regions comprise different countries.

4. The method of analyzing detected malware of claim 2, wherein creating the visualization further comprises creating a first visualization for malware samples having geographic location data for a command and control server and a second visualization for malware samples not having geographic data for a command and control server.

5. The method of analyzing detected malware of claim 1, wherein creating a visualization further comprises combining data by observation time period for visualization.

6. The method of analyzing detected malware of claim 1, wherein the time period for combining data comprises a day, a week, a month, or three months.

7. The method of analyzing detected malware of claim 1, wherein the database comprises malware detections received from a network of installed anti-malware tools configured to report detected malware to a central service.

8. The method of analyzing detected malware of claim 1, wherein creating the visualization further comprises illustrating a cluster of malware detections as an object having a size indicating the number of features in the clustered malware detections.

9. The method of analyzing detected malware of claim 8, wherein the object illustrating the cluster of malware detections has a size indicating the number of dynamic features in the clustered malware detections.

10. The method of analyzing detected malware of claim 8, wherein the object illustrating the cluster of malware detections has a size indicating the number of dynamic plus static features in the clustered malware detections.

11. The method of analyzing detected malware of claim 1, wherein creating the visualization further comprises illustrating a cluster of malware detections as an object having a size indicating the number of malware detections.

12. The method of analyzing detected malware of claim 1, wherein creating the visualization further comprises illustrating a cluster of malware detections as an object having a color indicating the number of different command and control servers associated with the malware detections in the cluster.

13. The method of analyzing detected malware of claim 8, wherein different command and control servers are grouped by country.

14. The method of analyzing detected malware of claim 8, wherein the object illustrating the cluster of malware detections has a characteristic indicating the number of features that vary between the clustered malware detections.

15. A malware characterization system, comprising:
a processor;
a memory;
a data structure configured to store information related to observed malware; and
software instructions stored in a machine-readable medium that when executed on the processor are operable to cause the system to select a family of related malware for evaluation from a database of observed malware, extract static and dynamic features of the malware samples from the selected malware family in the database and an observation time of each of the malware samples from the selected malware family, and create a visualization illustrating change in at least one of static and dynamic features of the selected malware family over time.

16. The malware characterization system of claim 15, further comprising extracting a geographic location of a command and control server associated with malware samples, wherein the created visualization further illustrates the number of distinct geographic areas in which the malware was found.

17. The malware characterization system of claim 16, wherein creating the visualization further comprises creating a first visualization for malware samples having geographic location data for a command and control server and a second visualization for malware samples not having geographic data for a command and control server.

18. The malware characterization system of claim 15, wherein creating a visualization further comprises combining data by observation time period for visualization, the time period for combining data comprises a day, a week, a month, or three months.

19. The malware characterization system of claim 15, wherein creating the visualization further comprises illustrating a cluster of malware detections as an object having characteristics indicating one or more of the number of features in the clustered malware detections, the number of malware detections during a period of time, the number of different command and control servers associated with the malware detections in the cluster, and the number of features that vary between the clustered malware detections.
